(19) United States
(12) Patent Application Publication
(10) Pub. No.: US 2014/0324243 A1
(43) Pub. Date: Oct. 30, 2014

(54) METHOD FOR DELIVERING CONTROL POWER BY USING ENERGY STORES

(71) Applicants: Georg Markowz, Alzenau (DE); Wolfgang Schweissthal, Mandelbachtal (DE); Carsten Kolligs, Bottrop (DE); Holger Brezski, Fernwald (DE); Wolfgang Deis, Heidelberg (DE); Michael Igel, Saarbruecken (DE); Anna Flemming, Frankfurt (DE); Dennis Gamrad, Voerde (DE); Sebastien Cochet, Oberhausen (DE); Stefan Winternheimer, Saarbruecken (DE)

(72) Inventors: Georg Markowz, Alzenau (DE); Wolfgang Schweissthal, Mandelbachtal (DE); Carsten Kolligs, Bottrop (DE); Holger Brezski, Fernwald (DE); Wolfgang Deis, Heidelberg (DE); Michael Igel, Saarbruecken (DE); Anna Flemming, Frankfurt (DE); Dennis Gamrad, Voerde (DE); Sebastien Cochet, Oberhausen (DE); Stefan Winternheimer, Saarbruecken (DE)

(73) Assignees: Evonik Industries AG, Essen (DE); Evonik Degussa GmbH, Essen (DE); STEAG Power Saar GmbH, Saarbruecken (DE)

(21) Appl. No.: 14/357,297

(22) PCT Filed: Oct. 26, 2012
(86) PCT No.: PCT/EP2012/071250

§ 371 Date: May 9, 2014

(30) Foreign Application Priority Data
Nov. 10, 2011 (DE) 10 2011 055 250.2

(51) Int. Cl. G05F 1/66; H02J 3/18

(52) U.S. Cl. CPC G05F 1/66; H02J 3/18
USPC 700/297

(57) ABSTRACT

The present invention relates to a method for delivering control power to stabilize an AC electricity network, the AC electricity network operating at a set frequency, comprising an energy store that can take up and deliver electrical energy, the energy store being connected to at least one unit for charging and/or discharging the energy store, the unit for charging and/or discharging the energy store drawing energy from the energy store or supplying energy to the energy store with a power of at most less than or equal to 20% of the contracted maximum power of the energy store.

The present invention relates to a method for delivering control power by using energy stores and to a device for carrying out such a method.

Electricity networks are used to distribute electricity from usually a number of energy generators in large areas to many users and to supply households and industry with energy. Energy generators, usually in the form of power plants, provide the energy required for this. Electricity generation is generally planned and provided to meet the forecast consumption.

Both when generating and when consuming energy, it is possible however for unplanned fluctuations to occur. These may arise on the energy generator side for example as a result of a power plant or part of the electricity network failing or, for example in the case of renewable energy sources such as wind, the energy generation being greater than forecast. It is also possible with respect to the consuming entities for unexpectedly high or low levels of consumption to occur. The failure of part of the electricity network, for example cutting off some consuming entities from the energy supply, may lead to a sudden reduction in the electricity consumption.

This generally leads to fluctuations in the network frequency in electricity networks due to unplanned and/or short-term deviations of the power generation and/or consumption. In Europe, for example, the desired AC frequency is 50 Hz. A reduction in consumption from the planned level leads to an increase in the frequency of power fed in as planned by the energy generators; the same applies to an increase in the electricity production as compared with the planned level when consumption is as planned. On the other hand, a reduction in the power produced by the energy generators as compared with the planned level leads to a reduction in the network frequency when consumption is as planned; the same applies to an increase in consumption as compared with the planned level when generation is as planned.

For reasons of network stability, it is necessary to keep these deviations within defined boundaries. For this purpose, depending on the degree and direction of the deviation, positive control power must be specifically provided by connecting additional generators or disconnecting consuming entities or negative control power must be specifically provided by disconnecting generators or connecting consuming entities. There is a general need for cost-effective and efficient provision of these supplies of control power, it being possible for the requirements for the capacities to be maintained and the dynamics of the control power sources or sinks to vary according to the characteristics of the electricity network.

In Europe, for example, there is a code of practice (UCTE Handbook), which describes three different categories of control power. In it, the respective requirements and the types of control power are also defined. Among the ways in which the types of control power differ are the requirements for the dynamics and the time for which power is to be delivered. They are also used differently with regard to the boundary conditions. Primary control power (‘PCP’) is to be delivered Europe-wide by all of the sources involved independently of the place of origin of the disturbance, this being substantially in proportion to the frequency deviation at the given time. The absolute maximum power has to be delivered when there are frequency deviations of minus 200 mHz and below (in absolute terms), the absolute minimum power has to be delivered when there are frequency deviations of plus 200 mHz and above. With regard to the dynamics, it is required that, from the non-operative state, the respective maximum power (in terms of the absolute amount) must be provided within 30 seconds. By contrast, secondary control power (SCP) and minutes reserve power (MRP) are to be delivered in the balancing periods in which the disturbance has occurred. Their task is to compensate as quickly as possible for the disturbance and thus ensure that the network frequency is restored as quickly as possible to the desired range, preferably at the latest after 15 minutes. With regard to the dynamics, lower requirements are stipulated for the SCP and MRP (5 minutes and 15 minutes, respectively, before full power is delivered after activation); at the same time, these power outputs must also be provided over longer time periods than primary control power.

In the electricity networks operated until now, a large part of the control power has been provided by conventional power plants, in particular coal-fired and nuclear power plants. This results in two fundamental problems. On the one hand, the conventional power plants providing control power are not operated at full load, and consequently maximum levels of efficiency, but slightly below, in order to be able when required to provide positive control power, possibly over a theoretically unlimited time period. On the other hand, with increasing expansion and increasingly preferred use of renewable energy sources, there are fewer and fewer conventional power plants in operation, which however is often the basic prerequisite for delivering supplies of control power.

For this reason, there are plans under development for increasing use of stores to store negative control energy and, when required, provide it as positive control energy.

The use of hydraulic pumped storage plants for delivering control power is state of the art. In Europe, all of the three types of control power mentioned above are delivered by pumped storage plants. Hydraulic pumped storage plants are however also repeatedly cited as currently the most cost-effective technology for storing and retrieving preferably forms of renewable energy, to allow energy supply and demand to be better adapted to one another in terms of time. The potential for the expansion of storage capacities is a controversial subject of discussion—in particular in Norway—since use requires considerable capacities in power lines to be approved and installed. Consequently, use for energy load management is in competition with the provision of control power.

Against this background, in the area of primary control power many plans for also using other storage technologies, such as for example flywheel mass and battery stores, for the provision of control power have recently been investigated and described.

US 2006/122738 A1 discloses an energy management system which comprises an energy generator and an energy store, the energy store being able to be charged by the energy generator. This is intended to enable an energy generator that does not ensure uniform energy generation in normal operation, such as for example the increasingly favoured renewable energy sources such as wind-power or photovoltaic power plants, to deliver its energy more uniformly into the electricity network. A disadvantage of this is that, although a single power plant can be stabilized in this way, all other disturbances and fluctuations of the electricity network cannot be counterbalanced, or only to a very limited extent.

It is known from WO 2010 042 190 A2 and JP 2008 178 215 A to use energy stores for providing positive and negative control power. If the network frequency leaves a range of tolerance around the desired network frequency, either energy is provided from the energy store or energy is taken up in the energy store, in order to control the network frequency. DE 10 2008 046 747 A1 also proposes operating an energy store in an island electricity network in such a way that the energy store is used to compensate for consumption peaks and consumption dips. A disadvantage of this is that the energy stores do not have the necessary capacity to compensate for a lengthy disturbance or a number of successive disturbances in the same direction with regard to the frequency deviation.

In the article “Optimizing a Battery Energy Storage System for Primary Frequency Control” by Oudalov et al., in IEEE Transactions on Power Systems, Vol. 22, No. 3 Aug. 2007, the capacity of a rechargeable battery is determined by technical and operational boundary conditions, in order that it can provide primary control power in accordance with the European standards (UCTE Handbook). It has been found that, on account of storage and retrieval losses, in the long term repeated charging or discharging of the energy store at different time intervals is unavoidable. The authors propose for this the time periods in which the frequency is in the deadband (i.e. in the frequency range in which no control power is to be delivered). Nevertheless, in the short term or temporarily, it may happen that the energy store is overloaded. The authors propose for such cases the (limited) use of loss-producing resistors, which in the extreme case can take up the complete negative nominal control power, that is to say have to be designed for this. Apart from the additional investment requirement for the resistors and their cooling, this however, as already mentioned by the authors themselves, leads to energy being destroyed to a more or less undesired extent, while the waste heat produced generally cannot be put to any use. The authors show that less reliance on loss generation is only possible by having a greater storage capacity, involving higher investment costs.

In light of the prior art, it is thus the object of the present invention to provide a technically improved method for delivering control power to stabilize an AC electricity network that is not affected by the disadvantages of conventional methods.

In particular, it should be possible for the method to be carried out as easily and inexpensively as possible. The plants with which the method can be carried out should involve lowest possible investments with respect to the control power provided.

It is intended thereby to make it possible to provide control power with a high degree of efficiency of the components used.

It can be seen as a further object of the invention that the capacity of the energy store for providing the required control power is intended to be as small as possible.

Furthermore, it is intended that the energy generators and energy consuming entities should have the most efficient possible energy yield as control power suppliers.

The method according to the invention is also intended to be suitable for allowing the necessary control power to be provided as quickly as possible as required.

In addition, it should be possible for the method to be carried out with fewest possible method steps, while these steps should be simple and reproducible.

Further, not explicitly mentioned objects emerge from the overall context of the following description and the claims.

These objects and further objects, which are not explicitly mentioned but readily emerge or are readily foreseeable from the contexts discussed in the introduction hereof, are achieved by a method having all the features of Patent Claim 1. Expedient modifications of the method according to the invention for providing control power for an electricity network at the control power are afforded protection in dependent Claims 2 to 9. Furthermore, Patent Claim 10 concerns a device for carrying out such a method.

Accordingly, the subject matter of the present invention is a method for delivering control power to stabilize an AC electricity network, the AC electricity network operating at a set frequency, comprising an energy store that can take up and deliver electrical energy, which is characterized in that the energy store is connected to at least one unit for charging and/or discharging the energy store, the unit for charging and/or discharging the energy store drawing energy from the energy store or supplying energy to the energy store with a power of at most less than or equal to 20% of the contracted maximum power of the energy store.

The method according to the invention succeeds in an unforeseeable way in providing a method for delivering control power to stabilize an AC electricity network that is not affected by the disadvantages of conventional methods.

In particular, the present invention makes it possible to provide control power with a high degree of efficiency of the components used.

Furthermore, the capacity of the energy store for providing the required control power can be kept very low.

Furthermore, the energy generators and energy consuming entities have a very efficient energy yield, and can be used for example as units for charging and/or discharging the energy store and/or as control energy suppliers.

The method according to the invention is also suitable for providing the necessary control power very quickly.

In particular, the method can be carried out as easily and inexpensively as possible, since the storage capacity required for full availability can be reduced.

According to the prior art, the energy stores are generally charged or discharged by way of the electricity network. This procedure may also be retained, the invention having the effect that these charging/discharging cycles to be carried out by way of the electricity network have to be carried out more rarely or do not have to be carried out at all. It can be stated here that the energy store can draw energy by way of the electricity network through the energy trade. This energy must be bought in and called at a specific time, since otherwise there is a disturbance of the system. The actual network frequency is of no consequence for this process, since the frequency of the electricity network is not influenced when there is a planned, simultaneous feed-in and removal of power. What is important, rather, is that the feed-in and removal of this power take place as synchronously as possible. When there is a constant capacity of the energy store, the operational lifetime of the store can be increased as a result of reducing the charging/discharging cycles that are carried out at a high level of power, this representing an important aspect, in particular for rechargeable batteries, that can be surprisingly improved by the present invention.

Furthermore, on account of the power that can be additionally provided by the unit for charging and/or discharging the energy store, the time before a feed-in or removal of energy is carried out by means of the electricity network can be increased, even in the case of high loading of the energy store because of a relatively long-term unilateral frequency deviation, and so the capacity can be correspondingly reduced.

In addition, the method can be carried out with very few method steps, while these steps are simple and reproducible.

The present method serves for providing control power to stabilize an AC electricity network. As already explained in the introduction, in an AC electricity network the frequency changes if the equilibrium between energy consumption and energy provision is not maintained.

The control energy or control power is delivered to the electricity network (positive control energy or positive control power) or is taken up from the electricity network (negative control energy or negative control power). Positive control power can be supplied to the network by feeding in energy, for example by inputting energy from an energy store or by connecting a power plant, or by restricting a consuming entity. Negative control power can be fed to the network by energy being taken up by an energy store, by restricting an energy source, for example a power plant, or by connecting a consuming entity into the electricity network. Further important information on this can be found in the prior art, reference being made in particular to the documents discussed in the introduction. It can be stated in this connection that the terms control power and control energy have a similar meaning.

Usually, control power for a certain nominal power is made available to the network operator by the supplier. In the present case, nominal power should be understood as meaning the power by which the control energy source that is being operated by a method according to the invention is at least prequalified. Generally, the network operator uses a prequalification process to check the capability claimed by the supplier to deliver control power. However, the prequalification power may be greater than the nominal power that is made available to the network operator as a maximum. This nominal power may also be referred to as contracted maximum power, since this power is provided to the network as a maximum.

The method according to the invention serves for stabilizing an AC electricity network. AC electricity networks are distinguished by an alternation of the polarity of the electrical current, with positive and negative momentary values matching up in such a way that on average over time the current is zero. These networks are generally used for the transmission of electrical energy.

The AC electricity networks are usually operated with a set frequency, which in Europe, in particular in Germany, is 50 Hz. In North America, on the other hand, the set frequency is 60 Hz. This set frequency is often also referred to as the desired frequency.

The network operator usually defines frequency bands around this set frequency, outside which positive or negative control power has to be fed into the network. Precise information on this can be found in European standards (handbooks) that have been prepared for operating the European interconnected system UCTE (Union for the Co-ordination of Transmission of Electricity) and are implemented in national guidelines (for example, the Transmission Code for Germany).

There are at present two tolerances for the sources for providing primary control power that are relevant with regard to the frequency deviations. One is the frequency measuring accuracy. This may be a maximum of +/−10 MHz. There is also what is known as a range of insensitivity of a maximum of +/−10 MHz, which is allowed for the sources delivering primary control power. In order to avoid the control power sources acting contrary to the desired direction under any circumstances, the transmission network operators in Germany have for example fixed in their outline agreements a band of +/−10 MHz around the setpoint value of 50 Hz, in which no primary control power may be delivered. Thus, even with a maximum frequency measuring accuracy of +10 MHz or −10 MHz, delivery of control power contrary to the desired direction is ruled out. Outside these limits, the contractual terms provide that control power must be provided. The bandwidth of this frequency band is not critical for the present invention, and can accordingly be adapted to the specifications of the network operators. This frequency band may also be referred to as a deadband.

At present, in Europe, control power is provided in full as from a specific maximum deviation of the network frequency (actual alternating current frequency) from the set frequency (setpoint alternating current frequency), with a deviation of +/−200 MHz. In the range between the deadband and the maximum deviation, in Europe it is intended that only a certain proportion of the maximum control power that can be provided is fed into the electricity network. The type of delivery of control power is not critical for the present invention. According to the regulations valid at present in Europe, the amount of power to be delivered should be increased largely linearly with increasing frequency deviation from the set frequency. Thus, usually when there is a deviation of 100 MHz, a control power that is 50% of the maximum power is delivered. This maximum power is delivered when there is a deviation of 200 MHz and corresponds to the previously defined nominal power or contracted maximum power for which the energy store is at least prequalified. When there is a deviation of 50 MHz, accordingly 25% of the nominal power is delivered.

Surprisingly, the capacity of the energy store for delivering a prescribed control power can be improved by using a unit for charging and/or discharging the energy store that makes energy available to the energy store when there is a very low level of power.

It can be stated in this connection that stabilization of the network can be achieved by the method even when there is a relatively small capacity of the energy store, since even then control can take place if, on average, the network frequency lies above or below the set frequency over a relatively long period of time. This makes it possible to provide a very high level of control power with a relatively small capacity of the energy store.

The unit for charging and/or discharging the energy store charges or discharges the energy store with a power less than or equal to 20%, preferably 10%, of the contracted maximum power of the energy store. In this connection, reference is made to the statements made above with regard to the contracted maximum power of the energy store and its prequalification.

This energy can be supplied to the energy store over a prescribed period of time, for example continuously, or at intervals, for example by way of pulses.

Furthermore, it may be provided that the supplying of energy into the energy store or removal of energy from the energy store is performed by a delivery of control power that is adapted to the state of charge of the energy store. This allows this state of charge to be transformed into an optimal or ideal charging state.

In particular, increased negative control power can be provided if the charging state of the energy store is very low on account of a network frequency which, on average, lies below the set frequency over a relatively long period of time. Tolerances, for example tolerances allowed by the network operator to the supplier delivering control power, with regard to the network frequency, the level of control power dependent on the frequency deviation, the insensitivity with regard to the change in frequency, and the period of time within which the control power is to be delivered, can be used to adapt the charging state of the energy store to the requirements. Thus, instead of the intended negative control power, for example at least 105%, preferably at least 110% and particularly preferably at least 115%, of this control power may be delivered. If therefore, with a low charging state, positive control power must be provided, the power that is contractually to be delivered is in this case provided as exactly as possible. Furthermore, the take-up of energy may take place directly when there is a low charging state, while the feed-in of energy takes place at a time that is as late as possible according to the regulations, or with a rise that is as slow as possible according to the regulations. Furthermore, the frequency tolerance allowed by the network operator may be used in that a measurement is carried out with a greater accuracy, the difference from the allowed measuring inaccuracy that is obtained as a result being specifically used in order when there is a low charging state to feed as little power as possible into the network according to the regulations, i.e. in the given tolerance boundaries, or to take up as much power as possible from the network. When there is a high charging state, the opposite procedure can be adopted. Thus, delivery of a high level of energy when providing a positive control power and take-up of a low level energy when providing a negative control power is possible or can be realized. In particular in connection with the way in which energy is fed in, this embodiment is suitable for keeping the charging state of the energy store in a relatively narrow range that ensures provision of negative and/or positive control power.

The tolerance with respect to the amount of the control power provided and the tolerance in the determination of the frequency deviation etc. should be understood according to the invention as meaning that, on account of technical boundary conditions, such as the measuring accuracy when determining the control power delivered or the network frequency, certain deviations between an ideal desired power and the control power actually delivered are accepted by the network operator. The tolerance may be granted by the network operator, but could also correspond to a legal provision.

According to a particular embodiment, the supplying of energy into the energy store may be dependent on the time of day. This allows a high degree of stability of the network to be ensured even when there is a high load at certain times of day. Thus, a regeneration of the energy store that would be appropriate on account of the deviation of the network frequency from the set frequency over a relatively long period of time can be ruled out when there are peak loads.

Furthermore, it may be provided that a number of energy stores are used according to the present method. In one particular embodiment, all or only some of these energy stores may deliver control power that is adapted to the state of charge of the energy stores in the manner described above.

The size of the energy stores within the pool may vary. In a particularly preferred embodiment, when using tolerances, in particular when choosing the bandwidth in the deadband, for the various energy stores of a pool, the change from one parameter setting to another is not performed synchronously but specifically at different times, in order to keep any disturbances in the network as small as possible or at least to a tolerable level.

In a further preferred embodiment, the tolerances used in the various procedures, in particular the choice of the bandwidth in the deadband, vary according to the time of day, the day of the week or the time of year. For example, in a time period from 5 minutes before to 5 minutes after the change of hour, tolerances can be defined more narrowly. The reason for this is that very often rapid frequency changes take place here. It may be in the interests of the transmission network operators that there are smaller tolerances here, and consequently the provision of control energy takes place more dependably, in the sense of more strictly.

According to a further embodiment, it may be provided within the provisions for delivering control power that on average more energy is taken up from the network by the energy store than is fed in. This may take place because, according to the regulations including the previously set out procedure, preferably a very large amount of negative control power is provided, whereas, according to the regulations including the previously set out procedure, preferably only the minimum assured amount of positive control power is delivered. Preferably, on average at least 0.1% more energy is taken from the network than is fed in, in particular at least 0.2%, preferably at least 0.5%, particularly preferably at least 1.0%, especially preferably 5%, these values being referred to an average that is measured over a time period of at least 15 minutes, preferably at least 4 hours, particularly preferably at least 24 hours and especially preferably at least 7 days, and relates to the energy fed in.

This may involve using the previously set out delivery of control power in order to take a maximum of energy from the network, the maximum possible negative control power being provided while only a minimum of positive control power is delivered.

In the embodiments of the preferred, and especially maximum, energy take-up, the supplies of energy thereby taken from the network can be sold through the previously described energy trade, this preferably taking place at times at which a price that is as high as possible can be achieved. Forecasts of the price development that are based on historical data may be used for this purpose.

Furthermore, the charging state of the energy store at the time of a planned sale of energy may be preferably at least 70%, particularly preferably at least 80% and particularly preferably at least 90% of the storage capacity, the charging state after the sale preferably being at most 80%, in particular at most 70% and particularly preferably at most 60% of the storage capacity.

According to the invention, an energy store that can take up and deliver electrical energy is used for carrying out the method. The type of energy store is not important for carrying out the present invention.

It may preferably be provided that a flywheel, a heat store, a hydrogen generator and store with a fuel cell, a natural gas generator with a gas-fired power plant, a pumped storage power plant, a compressed-air storage power plant, a superconducting magnetic energy store, a redox-flow element and/or a galvanic element, preferably a rechargeable battery or combinations (“pools”) of stores, is used as the energy store.

A heat store operated as an energy store must be operated together with a device for producing electricity from the stored thermal energy.

The rechargeable batteries include, in particular, lead batteries, sodium-nickel chloride batteries, sodium-sulphur batteries, nickel-iron batteries, nickel-cadmium batteries, nickel-metal hydride batteries, nickel-hydrogen batteries, nickel-zinc batteries, tin-sulphur-lithium-ion batteries, sodium-ion batteries and potassium-ion batteries.

Of these, rechargeable batteries that have a high efficiency and a high operational and calendar lifetime are preferred. Accordingly, among the preferred rechargeable batteries are in particular lithium-ion batteries, such as for example lithium-polymer batteries, lithium-titanate batteries, lithium-manganese batteries, lithium-iron-phosphate batteries, lithium-iron-manganese-phosphate batteries, lithium-iron-yttrium-phosphate batteries, and also further developments of these, such as for example lithium-air batteries, lithium-sulphur batteries and tin-sulphur-lithium-ion batteries.

Rechargeable batteries in particular are particularly suitable for methods according to the invention, on account of their rapid reaction time, that is to say both the response time and the rate at which the power can be increased or reduced. Moreover, the efficiency is also good, in particular in the case of Li-ion batteries. Furthermore, preferred rechargeable batteries display a high ratio of power to capacity, this characteristic value being known as the C rate.

It may also be provided that an energy of at least 4 kWh, preferably of at least 10 kWh, particularly preferably at least 50 kWh, most particularly preferably at least 250 kWh, can be stored in the energy store.

According to a further embodiment, the energy store may have a capacity of 1 Ah, preferably 10 Ah and particularly preferably 100 Ah.

When using stores that are based on electrochemical elements, in particular rechargeable batteries, this store may be advantageously operated at a voltage of at least 1 V, preferably at least 10 V and particularly preferably at least 100 V.

Depending on the variation of the frequency deviation, the feeding of control power into the AC electricity network may take place constantly, by way of pulses or by way of ramps, which are characterized by a rise in the power feed-in over a defined period of time.

Control power provided by way of pulses (impulses) makes it possible to improve the efficiency of the device and the method for providing control power, since in this way the power electronics that are necessary, in particular when rechargeable batteries are used, can be operated with a higher degree of efficiency. A pulse should be understood as meaning a sudden variation in current, voltage or power for a limited time, it also being possible for these pulses to be used as a repeated series of impulses. The duty cycle according to DIN IEC 60469-1 may be chosen here according to the type of power electronics and the control power to be delivered, this lying in the range from greater than zero to 1, preferably in the range from 0.1 to 0.9, particularly preferably in the range from 0.2 to 0.8.

In the event of changes in power being required, it may preferably be provided that the power of the energy store is increased depending on the level of the required change in power over a period of time of at least 0.5 s, preferably over a period of time of at least 2 s, particularly preferably over a period of time of at least 30 s.

It is ensured by these slower ramps that undesired disturbances or oscillations in the electricity network are not excited or caused by over-steep power gradients with the connected consuming entities and generators.

The charging state of the energy store to be aimed for may preferably lie in the range from 20 to 80% of the capacity, particularly preferably in the range from 40 to 60%. This charging state may be set in particular by way of the unit for charging and/or discharging the energy store. The direct access to this unit allows the charging state to be kept in a relatively narrow window, so that the capacity of the energy store can be reduced with comparable certainty and duration with regard to the delivery of control power. In particular in the case of rechargeable batteries as the energy store, the charging state corresponds to the state of charge (SoC) or the energy content (state of energy, SoE).

The charging state of the energy store to be aimed for may depend on forecast data. Thus, in particular, consumption data dependent on the time of day, the day of the week and/or the time of year may be used for determining the optimum charging state.

According to a particular embodiment, the power of the unit for charging and/or discharging the energy store can be controlled by way of the charging state of the energy store. Here, this power relates to the energy that is supplied to or removed from the energy store.

It may also be provided that the power of the energy store delivered to the electricity network or the power of the energy store taken up from the electricity network is measured at a number of times, in particular continuously, and the charging state of the energy store is calculated at a number of times, preferably continuously, the power of the energy store that is delivered or taken up being delivered in dependence on this charging state by way of an adapted delivery of control power of the energy store in the way explained above.

At least one unit for charging and/or discharging the energy store is used for carrying out the method according to the invention. In this connection, these units for charging and/or discharging the energy store are devices that can supply or remove energy to or from the energy store but do not constitute energy stores. The units for charging and/or discharging the energy store particularly include energy generators and energy consuming entities.

It may be provided according to the invention that a generator, for example a diesel generator, a power plant, preferably a coal-fired power plant, a gas-fired power plant or a hydroelectric power plant, is used as the energy generator and/or a works for producing a substance, in particular an electrolysis works or metal works, preferably an aluminium works or steelworks, is used as the energy consuming entity.

Such energy generators and energy consuming entities are well suited for setting the charging state of the energy store. According to the invention, their inertia does not constitute any obstacle if they are suitably combined with dynamic stores.

Preferred here in particular are units for charging and/or discharging the energy store that can also be used in connection with renewable energy sources, such as for example electrolysis works or metal works, the production of which can be reduced for charging the energy store.

According to a particular embodiment, energy consuming entities or energy generators with a low nominal power can be used for supplying or removing energy into or from the energy store. Energy consuming entities or energy generators with a low nominal power preferably have here a power that is at most 200%, preferably at most 100%, particularly preferably at most 50%, of the contracted maximum power of the energy store.

Depending on the type of energy store, the unit for charging or discharging the energy store may have a nominal power output that comprises at least 1 kW, preferably at least 10 kW, vertically preferably at least 100 kW. In the case of a pool of energy stores or in the case of particularly large energy stores, this power output may also be much greater, for example at least 1 MW.

Furthermore, these units for charging and/or discharging the energy store may be operated with a high power output, though according to the invention generally only a small part of this energy is used for setting the charging state of the energy store. Energy consuming entities or energy generators with a high nominal power that can be used as units for charging and/or discharging the energy store preferably have a power that is at least 200%, preferably at least 250%, particularly preferably at least 500%, of the contracted maximum power of the energy store. This makes it possible to operate the energy generators and/or energy consuming entities with a very high degree of efficiency, since only a very small part of the nominal power of the energy generators and/or energy consuming entities is required for setting the charging state of the energy store.

In a further embodiment, it may be provided that the method is additionally carried out with a supplier delivering control power that is capable of supplying or removing a higher proportion of energy to or from the electricity network and/or the energy store than the unit for charging and/or discharging the energy store. This unit is accordingly suitable for providing control energy or control power.

Suppliers delivering control power are in this connection devices that can provide control power but do not constitute energy stores. The suppliers delivering control power particularly include energy generators and energy consuming entities, exemplary embodiments of these components having been described above.

In this embodiment it may be provided that the energy generator and/or the energy consuming entity individually or in the pool has or have a power output of at least 100 kW, preferably at least 1 MW, particularly preferably at least 10 MW.

The ratio of nominal power of the energy store to the maximum power of the supplier delivering control power may preferably lie in the range from 1:10 000 to 10:1, particularly preferably in the range from 1:1000 to 1:1.

With these levels of power, a control energy source can still be reasonably operated, even for a large electricity network.

A combination of a supplier delivering control power and an energy store particularly allows a permanent provision of control power to be achieved, without there being any limitation with regard to a charging state or a capacity of the energy store. Thus, when there is a minor deviation of the average value from the set frequency, the supplier delivering control power can supply to or take from the energy store the energy that the energy store has fed into the network or removed from the network on account of this deviation in order to bring about control to the set frequency. This generally requires relatively small amounts of energy. When there is a sustained deviation of the network frequency, in particular over relatively long times of at least 10 minutes, preferably at least 15 minutes and especially preferably at least 30 minutes, the control power supplier can at least partially take the place of the energy store.

Thus, in spite of a relatively high inertia of the control power suppliers, high-quality control power can be delivered by way of the energy store that is capable of responding very quickly. When there is long-term deviation, the control power supplier can deliver the assured control power completely, for example until the network frequency allows a regeneration of the energy store, that is to say charging or discharging of the same to an optimal or ideal state of charge.

Preferred here in particular are suppliers delivering control power that can be used in connection with renewable energy sources, such as for example electrolysis works or metal works, the production of which can be reduced for providing positive control power.

This embodiment surprisingly allows the nominal power of the energy store to be increased without the capacity of the same having to be increased. It is possible thereby for control power to be provided to the energy store by the supplier delivering control power in a very short time as required, even when there is high network loading, without laborious energy trading being necessary. Surprisingly, therefore, a relatively high power output, which generally can only be delivered for a short period of time, can be delivered with a relatively small capacity. The direct access to the supplier delivering control power allows the latter to deliver the control power that actually has to be made available to the energy store after a short time. Thus, in particular, a regeneration of the energy store can take place by the energy or power of the supplier delivering control power. The energy store contributes here to the quality of the control power, since a rapid response time is achieved by it. By contrast, the supplier delivering the control power contributes to the quantity, since it can deliver control power at relatively low costs over a type-dependently indeterminate, much longer time.

The method of the present invention can preferably be carried out with a device which comprises a control system and an energy store, the device being connected to an electricity network and the control system being connected to the energy store, the control system being connected to a unit for charging and/or discharging the energy store and a unit for determining the energy that is to be supplied to or removed from the energy store.

It may be provided in this case that the device comprises a frequency meter for measuring the network frequency of the electricity network and a memory, at least one limit value of the network frequency (for example set frequency +/−10 MHz, set frequency +/−200 MHz, etc.) being stored in the memory, the control system being designed for comparing the network frequency with the at least one limit value and, in dependence on the comparison, controlling the power of the energy store and of the unit for charging and/or discharging the energy store, in particular of the energy consuming entity and/or the energy generator.

In the present case, a control system is understood according to the invention as meaning a simple control system. It should be noted here that any closed-loop control comprises an open-loop control, since in closed-loop control an open-loop control takes place in dependence on a difference between an actual value and a setpoint value. The control system is therefore preferably formed as a closed-loop control system, in particular with respect to the charging state. Particularly preferably, the control system is a master control system.

It may also be provided that the device has a data memory, the data memory storing at least historical data concerning the deviation and the duration of the network frequency from the set frequency, these historical data covering a time period of preferably at least one day, preferably at least one week, particular preferably at least one month and especially preferably at least one year. This memory may serve in particular for storing the optimum charging state of the energy store.

The unit for charging and/or discharging the energy store may comprise one or more of the energy consuming entities and/or energy suppliers described above. Preferred in particular is an energy consuming entity that can be restricted, so that the power generally provided to the energy consuming entity by way of the electricity network can be partially used if need be for regenerating the energy store.

This embodiment may be expedient for example when using restrictable consuming entities, the power take-up of which is very high, while a relatively small part of this power can be used for charging or discharging the energy store. In this embodiment, the consuming entity can be operated with a very high degree of efficiency and at the same time bring about the previously described improvements with regard to the delivery of control power by the energy store.

Furthermore, the device may have a unit for determining the energy that is to be supplied to or removed from the energy store. This unit generally comprises a charging state meter, which measures the charging state of the energy store, the charging state being adapted to the previously described optimum values when previously defined limit values are reached.

In the following text, exemplary embodiments of the invention are explained on the basis of a schematically depicted FIGURE, without however restricting the invention in the process. In detail:

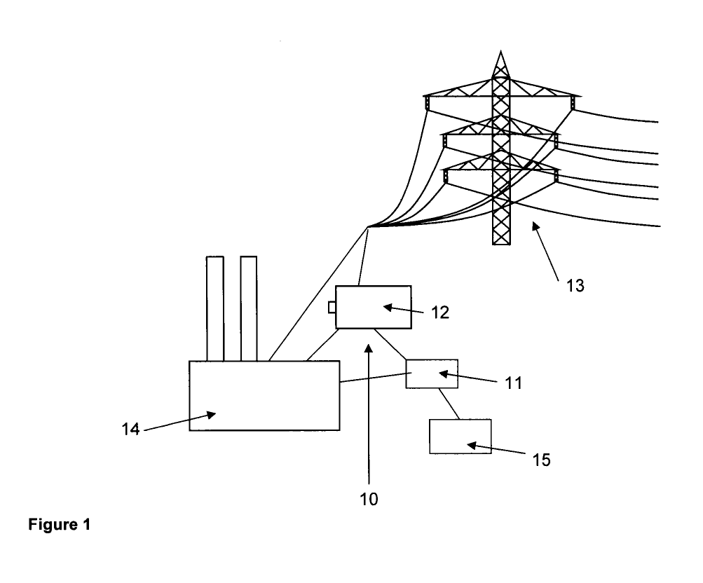

FIG. 1: shows a schematic representation of a device according to the invention for providing control power.

FIG. 1 shows a schematic structure of a preferred embodiment of a device 10 according to the invention for a method according to the invention, comprising a control system 11 and an energy store 12, the device being connected to an electricity network 13.

Also in such cases in particular, a particularly quickly reacting and easily chargeable and dischargeable energy store 12 is particularly advantageous. Rechargeable batteries are best suited for this. Li-ion batteries in particular can be quickly and frequently charged and discharged with scarcely any harmful influences on the battery, and so these are particularly suitable and preferred according to the invention for all of the exemplary embodiments. For this, Li-ion batteries with a considerable capacity must be provided. These can for example be easily accommodated in one or more 40 foot ISO containers.

The control system 11 is connected here to the energy store 12. Furthermore, the control system 11 is connected to a unit for charging and/or discharging the energy store 14 and a unit for determining the energy that is to be supplied to or removed from the energy store 15. The connection between the unit for charging and/or discharging the energy store 14 and the control system 11 and between the unit for determining the energy that is to be supplied to or removed from the energy store 15 and the control system 11 allows communication of the data determined, which are processed in the controlling unit. Furthermore, the control system 11 may be connected to the electricity network 13, it being possible for this connection, which is not represented in FIG. 1, to allow a transmission of requests for required control power, both positive and negative. The unit for charging and/or discharging the energy store 14 may preferably be in connection with the electricity network 13, as schematically represented in FIG. 1. This embodiment is expedient in particular when using restrictable consuming entities, the power take-up of which may be very high, while a relatively small part of this power can be used for charging or discharging the energy store. In this embodiment, the consuming entity can be operated with a very high degree of efficiency and at the same time bring about the previously described improvements with regard to the delivery of control power by the energy store.

For details on controlling control power and for exchanging information with the network operators, reference should be made to the forum of network technology/network operation of the VDE (FNN) “TransmissionCode 2007” of November 2009.

The features of the invention that are disclosed in the description above as well as the claims, figures and exemplary embodiments may be essential both individually and in any desired combination for realizing the invention in its various embodiments.

1-10. (canceled)

11. A method for delivering control power to stabilize an AC electricity network, the AC electricity network operating at a set frequency, and including an energy store that can take up and deliver electrical energy,
wherein the energy store is connected to at least one unit for charging and/or discharging the energy store,
the unit for charging and/or discharging the energy store drawing energy from the energy store or supplying energy to the energy store with a power of at most less than or equal to 20% of contracted maximum power of the energy store.

12. A method according to claim 11, wherein the unit for charging and/or discharging the energy store draws energy from the energy store or supplies energy to the energy store with a power of at most less than or equal to 10% of the contracted maximum power of the energy store.

13. A method according to claim 11, wherein the supplying of energy into the energy store or removal of energy from the energy store is performed by a delivery of control power that is adapted to a state of charge of the energy store.

14. A method according to claim 11, wherein the unit for charging and/or discharging the energy store is an energy generator.

15. A method according to claim 11, wherein the unit for charging and/or discharging the energy store is an energy consuming entity, a power of which is reduced to provide energy to the energy store.

16. A method according to claim 11, wherein the energy store is a rechargeable battery.

17. A method according to claim 16, wherein the rechargeable battery is a lithium-ion battery.

18. A method according to claim 11, wherein the power of the unit for charging and/or discharging the energy store is controlled by a charging state of the energy store.

19. A method according to claim 11, wherein, within provisions for delivering control power, on average more energy is taken up from the network than is fed in.

20. A device for carrying out a method according to claim 11, comprising:
a control system and an energy store,
the device being connected to an electricity network and the control system being connected to the energy store, the control system being connected to the unit for charging and/or discharging the energy store and a unit for determining energy that is to be supplied to or removed from the energy store,
wherein the unit for charging and/or discharging the energy store is an energy consuming entity, power take-up of which can be restricted.
